(19) United States
(12) Patent Application Publication
(10) Pub. No.: US 2017/0024762 A1
(43) Pub. Date: Jan. 26, 2017

(54) SYSTEM AND METHODS FOR MONETIZING DIGITAL ASSETS

(71) Applicant: Sambasivan Swaminathan, 5 Goldenrod Dr, NJ (US)

(72) Inventor: Sambasivan Swaminathan, 5 Goldenrod Dr, NJ (US)

(21) Appl. No.: 14/803,319

(22) Filed: Jul. 20, 2015

(51) Int. Cl. G06Q 30/02

(52) U.S. Cl. CPC G06Q 30/0251; G06Q 30/0277

(57) ABSTRACT

A system and method for placing advertisements, where obtaining some information about at least one product is acquired, that information is transformed into a product catalog, that product catalog is used to create a promotion, which is pushed to a particular segment of viewers browsing the internet, via a real-time bidding service. It is also possible to log the performance of these promotions and to visualize the data associated with this logging.

### CLAIM OF PRIORITY

This application claims no priority to any previous patent or patent application.

### FIELD OF THE EMBODIMENTS

This invention relates to systems and methods for monetizing digital assets. In particular, the present invention relates to a system and method for turning products listed on a website into a digital catalog that may be easily interfaced into a real-time bidding advertisement exchange.

### BACKGROUND OF THE EMBODIMENTS

In the digital world, more and more products are being monetized through the use of advertising. While there is no shortage of ways for advertisers to display their content on the web, traditional advertising methods such as buying a number of views (impressions) in bulk for a set amount leaves both publishers and advertisers wanting more. This is logical. Publishers such as website owners and content creators attract a highly specific audience, an audience that a specific set of products appeals to. Whomever sells those products would certainly pay a premium to reach that specific audience, but also does not want to pay for fetching a targeted advertisement for an uninterested user. Accordingly, a system was created that allows advertisers to place advertisements only in front of the most high-value viewers. This system employs what is known as a real-time bidding service.

Generally, a real-time bidding service is comprised of a demand-side platform, publishers, and supply-side platforms, and an ad exchange. A demand-side platform is a piece of software and associated hardware that enables a number of publishers to disclose what kind of availability they have. For example, a publisher may have a viewer who is 25-years-old, male, and interested in hardware. The publisher's web server logs this and transmits this information to a demand-side platform. This platform then informs advertisers, ad exchanges, and supply-side platforms of this availability, allowing each to bid on delivering a digital advertisement to the viewer. For publishers, a demand-side platform is used to set the buying parameters of the campaign, monitor the number of advertisements served, and to whom those advertisements are being served on.

A supply-side platform is used by advertisers to enable them to effectively bid on a given delivery of an advertisement and to ensure that particular inventory is being displayed to a particular type of viewer. An Ad exchange is a software tool that facilitates this sale, which holds the auction between the various demand-side platforms and advertisers through various media.

While real-time bidding was originally used only on advertiser's surplus stock, due to the high value delivered to both the publisher and the advertiser, this type of advertising has been used increasingly on retailer's and advertiser's primary stock. This trend is generally good for the industry, however, the high level of technical knowledge required to participate in such a system serves as a barrier for a number of market participants, particularly the less sophisticated participants. Thus there is a need for a tool that enables more users, both publishers and advertisers, to be able to avail themselves of the benefits of real-time bidding services.

Examples of related art are described below:

U.S Patent Publication No. 2012/0046996 discloses a unified data management platform which creates audience segments by combining proprietary and third party data, assists in determining what data to buy and how to manage all aspects of third party purchased data, controls data permissions by client, tracks data utilization, and attributes and reports data cost. The platform provides solutions that address how to leverage custom audience segments across multiple demand side platforms (DSPs).

U.S Patent Publication No. 2014/0278943 discloses an interactive digital advertising system and method may include an advertising component for generating qualified leads in response to a lead request. The advertising unit may interact with responders based at least in part on the selected pre-screening inquiries to collect responder information. The advertising component may use responder information to evaluate and validate the responders based on criteria defined by a lead requestor. The advertising component may identify potential matches with lead requestor offers or services in real-time. The qualified leads generated by the advertising component may then be offered to the lead requestor.

U.S Patent Publication No. 2011/0231260 discloses an online video advertising platform and marketplace. The present invention enables sellers to enhance the way they market products by providing them with a platform that uses location, images, product information, and Internet video. Because images and text are static and videos are dynamic, a seller can better represent their product and receive a better price and quicker sale as a result of the dynamic presentation. When a new user is created, there is both an entry in the database, and file structure with the username or other unique identifier in the file system. The database then stores pointers to these files. All listings are tied to a central product (listing) Id (PID). Videos can be searched for by both video and product related metrics. Videos file themselves are tagged with product metadata.

U.S Patent Publication No. 2009/0132365 discloses an improved electronic commerce and advertising platform that aggregates transaction data from merchants and consumers. A set of enhanced scenarios built on the platform span both the online and offline transactional and advertising universe to the benefit of all participants of the electronic commerce and advertising platform. Transactional data and profile data can be leveraged within a social network to recommend activities, such as which restaurants come recommended by friends of a user.

U.S Patent Publication No. 2006/0026061 discloses a platform for enabling an online advertising marketplace. Methods, systems, and apparatuses are provided for computerized management of advertising campaigns using the platform. Computerized methods and systems are provided that facilitate or automate management of advertising campaigns, including advertising campaigns or campaign components that use sponsored search result listings. Information relating to advertising campaigns and advertising campaign performance is collected from disparate sources, integrated, and utilized to facilitate determination of optimal ad campaign strategies as well as to facilitate management of ad campaigns and implementation of ad campaign strategies.

U.S Patent Publication No. 2013/0125012 discloses a device that receives a user profile associated with a user of a user device, where the user profile is generated based on information associated with one or more transactions performed by the user, via the user device, with a first web site. The device also receives, from a second web site, a cookie associated with the user device. The device further generates, based on the user profile and when the cookie is received, an advertisement customized to the user, and provides, to the second web site, the advertisement customized to the user.

U.S Patent Publication No. 2012/0290908 discloses techniques for retargeting contextually-relevant user-generated data are described, including detecting an event associated with a widget embedded on a website, and configured to initiate a call to a service to retrieve content contextually relevant to the website, storing a file associated with a browser on a computing device, the file being configured to store the data, generating an identifier to send to the service when the file indicates the browser is configured to display other data associated with another website and being configured to provide a parameter to identify the content, retrieving the content using the identifier, the content being stored in a repository, rendering a display in an interface, and enabling a hyperlink associated with the content and configured to point to a website other than the website or another website, the content being retrieved from the website using a crawler.

U.S Patent Publication No. 2009/0132365 discloses an improved electronic commerce and advertising platform that aggregates transaction data from merchants and consumers. A set of enhanced scenarios built on the platform span both the online and offline transactional and advertising universe to the benefit of all participants of the electronic commerce and advertising platform. Transactional data and profile data are used to customize search and advertising results for specific users or groups of users. Transactional data and profile data can be leveraged within a social network to recommend activities, such as which restaurants come recommended by friends of a user.

U.S Patent Publication No. 2012/0089454 discloses a computer system that provides a selectively programmed Web architecture that implements a procedure and method for selectively serving to a Web page one or more electronic ads wherein the selection process is governed in part by application of a statistical algorithm. In a preferred embodiment of the inventive technology, the system manages and serves electronic ads for affiliated Web page publishers and advertisers. A computer-implemented method in accordance with the disclosed technology receives a request for an electronic advertisement for a Web page, wherein the Web page is associated with a Web page publisher, one or more electronic ads are selected using a statistics based approach, and the one or more electronic ads are communicated to the Web page for display.

U.S Patent Publication No. 2014/0279074 discloses a data management apparatus for digital advertising includes a data integration processor for collecting and storing data from providers, resolving heterogeneity of the data at schema and data levels, and performing validity checks of the data; an analytics processor for receiving validated data from the data integration processor and providing to users custom, nesting-aware, SQL-like query language and a library of data mining methods, machine learning models, and analytical user profiles (AUP); and an activation processor for encapsulating complex computations performed in real-time, segment evaluation, and online user classification using runtime user profiles (RUP).

U.S Patent Publication No. 2009/0199107 discloses an end-to-end mobile advertising system characterizes user behavior (e.g., location, interaction with advertisements on a mobile communication device, etc.) in order to select micro-targeted advertisements. A marketplace platform handles the formatting required for presentation suitable for mobile communication devices in accordance with negotiated tags for a desired audience (“reach”), for a suitable number of presentations (“frequency”) and for an effective duration (“time”) within a particular scheduled window. Effectiveness is gauged by monitoring user location and/or interaction with the communication device to see a change in behavior (e.g., whether goes to a location of a competitor or advertiser, calls the advertiser, clips the advertisement, etc.). This effectiveness is further tracked across applications and/or platforms to capture reach, frequency, and duration of a particular advertising campaign for a user. The marketplace platform secures user identification for privacy reasons from advertising entities that provide the advertisements.

Chinese Patent Document No. 103093374 discloses a method and a system capable of achieving the mobile advertisement. Each business platform is mutually independent in a mobile advertisement platform. The system capable of achieving the mobile advertisement comprises a digital advertisement platform, a mobile medium inserting platform, an operation management platform, a business data service engine and a business data base, wherein the digital advertisement platform is used for receiving advertisement injecting requirements of an advertising client, the mobile medium inserting platform is used for receiving inserting requirements of a platform businessman and achieving inserting of the platform businessman, the operation management platform is used for receiving business management requirements in the mobile advertisement system and achieving business management functions in the mobile advertisement system, the business data service engine is used as a link between the platform businessman and the advertising client, the platform businessman obtains the advertisements through the business data service engine, the advertising client injects the advertisements through the business data service engine, and the business data base is used for storing business data. Due to the fact that the business platforms are separated, updating and maintenance of the platform, and expanding and counting of the data are benefited, and therefore performance of the system is improved.

International Patent Application No. WO 2014022231 discloses a system for retargeting customers is based on a mobile device query initiated by a user, and includes a query module configured to receive a query with geographical information from the mobile device and determine geographical identifiers of the mobile device. An indexed database stores an aggregated plurality of customers having a geographical identifier proximate to the determined geographical area, and a processor selects an advertiser located proximate to the determined geographical area. A performance feedback module is configured to assign an effectiveness rating to one or more advertisements provided by the selected advertiser based on marketing attributes of the aggregated plurality of customers. An advertisement recommendation module then recommends one or more advertisements provided by the selected advertiser based on the assigned effectiveness rating, and the aggregated plurality of customers are retargeted by transmitting the recommended advertisements to one or more customers of the aggregated plurality of customer

European Patent Document No. 1222592 discloses an interactive advertising-based transaction-enabling network system and methods for implementing user-authenticated E-Commerce services. The network system comprises a plurality of “online” web servers (30) that are accessible via public “online” user-interface units, such as PC's (1000, 3000), TV's (2000), PDA's, and cell phones (1800, 3500), and “onsite” servers that are accessible via private “onsite” links using “onsite” user-interface units at commercials sites. The system further comprises a number of server-based apparatuses, all of which construct an “online” data center that communicates with a plurality of online and onsite servers.

### SUMMARY OF THE EMBODIMENTS

The present invention provides for a method of advertising, comprising the steps of: obtaining, at least one item of information from at least one data source; transforming, said at least one item of information into a product catalog, said product catalog comprising at least one product; creating, at least one segment from at least one criterion; creating, at least one promotion, wherein said promotion is designed to advertise said at least one product to said at least one segment.

The present invention also provides for a system comprising: a data management platform having a console and at least one store, wherein said console is comprised of a dashboard displayed on a viewing screen; at least one instance of a real-time bidding server having a decision engine; wherein said real-time bidding server interfaces with at least one instance of an advertising exchange server. Further, in a preferred embodiment said data management platform receives at least one item of information from a catalog feed and is capable of generating a promotion. In many embodiments, the console of the data management platform enables a user to: define at least one audience segment; create at least one dynamic advertising unit; assign said at least one audience segment to said at least one dynamic advertising unit; and analyze, plan, configure, and execute a digital advertising campaign, among other things.

In a preferred embodiment, the present invention will enable a user without a formal catalog feed to have a product catalog generated for them. The system of the present invention is capable of crawling a user's website such that a product catalog may be automatically generated. This functionality greatly lowers the bar of entry for advertisers looking to enter the arena of real-time bidding systems.

It is an object of the present invention to assist in identifying actionable audience segments.

It is an object of the present invention to create actionable audience segments based on a viewer's behavioral patterns.

It is an object of the present invention to serve catalog driven dynamic ads.

It is an object of the present invention to serve product recommendations tailored for a viewer.

It is an object of the present invention to create dynamic ads from a catalog feed.

It is an object of the present invention to provide functionality that allows a user to crawl a given website and automatedly create a digital product catalog.

It is an object of the present invention to monetize a given audience segment as premium inventory.

It is an object of the present invention to provide a streamlines platform to support marketing and advertising needs of ecommerce marketplaces and sellers.

### BRIEF DESCRIPTION OF THE DRAWINGS

FIG. 1 shows a flow chart of an embodiment of the method of the present invention.

FIG. 2 shows an embodiment of the technology stack of the system of the present invention.

FIG. 3 shows a potential monetization strategy of the system and method of the present invention.

FIG. 4 shows a flow chart of an embodiment of the system and method of the present invention.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

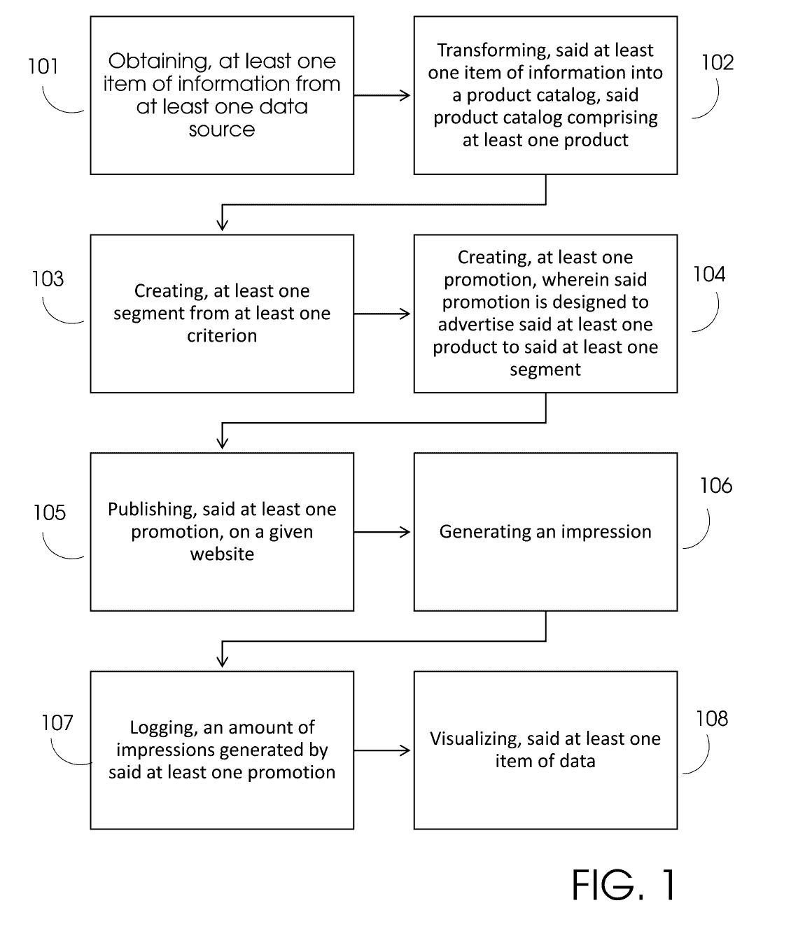

Referring to FIG. 1, a flow chart showing a preferred embodiment of the method of the present invention is provided for. This method begins with step 101, the step of obtaining at least one item of information from at least one data source. In a preferred embodiment, the at least one data source is a catalog feed. However, in another preferred embodiment, the at least one data source need not be a catalog feed, as the present invention is capable of crawling a user's website to obtain said at least one item of information. Preferably, this at least one item of information will be more than one item, and will consist of a user's products. Upon obtaining the at least one item of information from the at least one data source, the method proceeds to step 102. There, the at least one item of information is transformed into a catalog, preferably having a predetermined format. This product catalog will be stored digitally, and is the basis for the remainder of the method. Put simply, the promotions developed are based off of the entries in the product catalog transformed from said at least one item of information. In a preferred embodiment, the product catalog will consist of a plurality of entries, each with an SKU, an image, a subtitle, and a title for each product.

Turning to step 103, this embodiment of the method of the invention then proceeds to create, at least one segment. That is, a user will then choose a segment of viewers that it would like to subject a given advertisement to. That is, a user will choose to whom they would like to advertise. For example, a user may desire to advertise a subset of their product catalog to males aged 25-35, browsing the internet from somewhere in New England. In one embodiment, a user will merely have to use the console of the data management platform of the system of the present invention to create a new audience segment. In a preferred embodiment, a user will be able to define an audience segment in terms of operating system used, region, country, browser, name, device, city, region, sate, product ID, age, income band, gender, profession, and country.

Preferably, a user will create a segment that is tailored towards one of more of their products. After at least one segment has been created, this embodiment of the method of the present invention proceeds to step 104. Step 104 comprises creating, at least one promotion, where this promotion is an advertisement or advertisements that are designed to advertise a specific product or products to a given segment. Promotions may be tracked across all of the publishers who serve the promotion. Further, promotions may take a number of forms. The present disclosure contemplates video promotions, banner promotions, dynamic banner promotions, and mobile promotions. Promotions have a number of parameters. An impression is when an advertisement is fetched from its source and is countable. Preferably, a promotion will have a name, a desired cost-per-click, a desired cost-per-thousand-advertising impressions (CPM), a daily limit of the amount of impressions that should be generated, a total limit of the amount of impressions that should be generated, the dimensions of the promotion, a frequency cap (limit on amount of advertisements served to a given viewer), various classifications, a schedule for the promotion to run, locations of where the audience should be, where on a webpage the promotion should be rendered, the devices upon which the promotion will be served, and a list of white-listed and black-listed websites, along with other, not explicitly mentioned features. After the user has created at least one promotion to use with their product catalog and particular audience segment, the method proceeds to step 105 where the promotion is actually published on a website. Preferably, this will be done through the use of supply-side platforms, demand-side platforms, and ad exchanges or some combination thereof. This is to make sure that the most-relevant publishers publish the promotion, and to ensure that a proper value is paid for the impression. The method then proceeds to step 106 where an impression is generated. This merely means that the promotion was published to a member of the desired audience segment (the viewer), and the viewer viewed the promotion, generating what is known as an “impression.” In many embodiments of the method of the present invention, step 106 is the final step of the method. However, in additional embodiments of the method of the present invention, step 107 occurs, wherein the nature and amount of the impressions generated in step 106 are logged and analyzed by the system of the present invention. It should be noted that only a subset of all of the embodiments contemplated by the present invention employ step 108. There, the information logged regarding the generated impressions is visualized in a manner such that a user may see the results of their advertising campaign, and use the console of the system of the present invention to alter their advertising strategies to better generate revenue.

In various embodiments, the method of the present invention can be tailored towards different types of potential customers. As a non-limiting example, the method may be targeted for viewers unaware of a given product. The present invention is capable of ascertaining this by accessing a viewer's browsing history and determining if the viewer has accessed the user's website or any related websites. In an alternative embodiment, the present invention will determine that a viewer is interested in a product, but has not purchased the product yet. This can be ascertained by a viewer visiting the user's website, resulting in the being tagged to receive promotions tailored to someone who has an interest. As this user browses the web, they will be targeted and retargeted by the present invention with the appropriate advertisement. In a preferred embodiment, the viewer is shown a number of products that they might be interested in, due to their interest in the first product. In yet another preferred embodiment, the present invention is capable of generating personalized offers to regular customers based on their browsing and purchasing habits. In an alternative embodiment, the present invention is capable of issuing rewards to a repeat customer.

It seems salient to provide a non-limiting example. Under a preferred embodiment of the method of the present invention, a user could be the owner of a hardware store. While the user would preferably have a catalog feed that can be directly integrated into the method, the user need not have their data in an organized form, provided that the pertinent information is located somewhere on the user's website. From this information, a digital product catalog is generated by the system performing the method. In a preferred embodiment, this catalog will be comprised of a plurality of entries of products, each entry with relevant information about the product. Such information includes, but is not limited to, the item's SKU, title, subtitle, category of product, and an image of the product itself. Once the product catalog has been created, a this user would then proceed to make at least one audience segment of customers that they would like to advertise to. For example, a segment could consist of male viewers aged 18-30, who have browsed at least one website related to hardware. Once the user has defined their segment, they will create a promotion to advertise a given product or products to that segment. For example, the user could create a promotion to sell a particular hammer in their inventory. This promotion could take many forms, although in this particular example, the user creates a dynamic banner promotion. He would set the CPM and CPC, as well as the daily limit and total limit. Once set, the system of the present invention would begin to engage a real-time bidding platform and begin to publish the promotion across the internet, generating impressions. Preferably, these impressions would be logged by the system and visualized into helpful metrics for the user to monitor the progress and effectiveness of a given promotion.

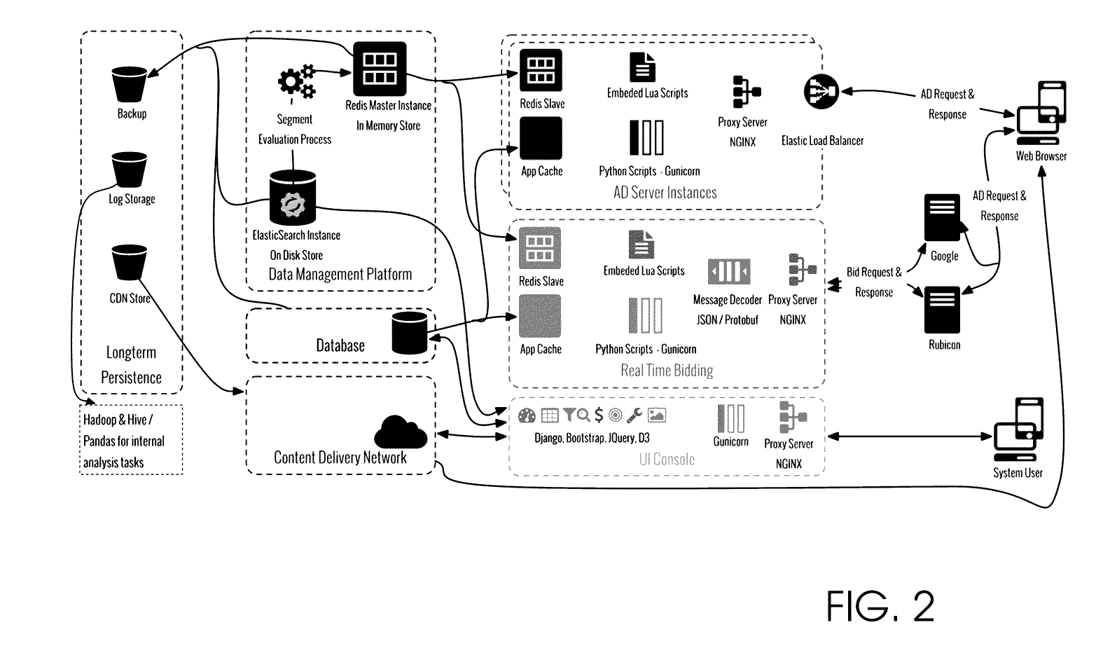

Referring to FIG. 2, a preferred embodiment of the technology stack of the system of the present invention is shown. Here, a data management platform having a console and at least one store is shown. This console is preferably comprised of a dashboard displayed on a viewing screen. This dashboard is typically skinned with a graphical user interface, but may comprise textual elements as well. In a preferred embodiment, the system is further comprised of at least one instance of a real-time bidding server having a decision engine, where this real-time bidding (RTB) server interfaces with at least one instance of an advertising exchange server. This RTB server enables a user to meaningfully participate on in online advertising. Frequently, when a viewer clicks a link to a given publisher's website, the entire bidding process is performed in a 200 millisecond time span. The RTB server will consider the parameters given to a particular promotion, and will employ them when determining which impressions it would to generate. If the user is selected as the winning bidder, the system will push a promotion, housed on a database through a content delivery network to the viewer via a content delivery network store. Preferably, the promotion in the database is run through a backup, but this is not mandatory.

In a preferred embodiment, the system is capable of selected advertisements through the use of artificial intelligence, predictive analytics, and deep learning. In yet another preferred embodiment the user-interface console of the data management platform of the present invention will be optimized for a mobile interface. In another embodiment of the present invention, the system is equipped with malware protection.

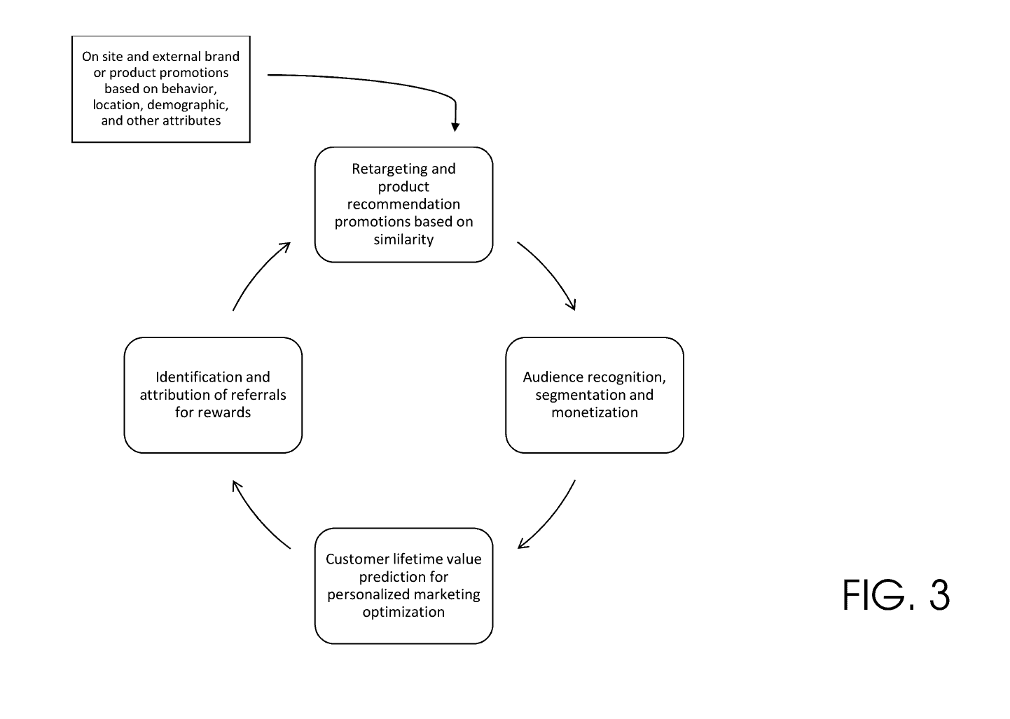

Referring to FIG. 3, a potential monetization strategy of the system and method of the present invention is provided for. In this system, first on site and external brand or product promotions are generated based on a given users' location, age, sex, religion, and behavior are created. As this user continues to browse the internet, they are shown similar ads at all of the websites they visit. This is known as “retargeting” and is done most effectively when the recommended promotions are based on similarity. After this is done a sufficient amount of times, the system and method of the present invention are able to recognize given audience segments and determine their potential level of monetization. From this point, the system and method of the present invention are capable of determining the customer lifetime value prediction and can create a personalized marketing campaign for that given customer. From here, the customer is identified as a satisfied customer and is given incentives to refer their personal contacts. Upon a referral, the cycle begins anew.

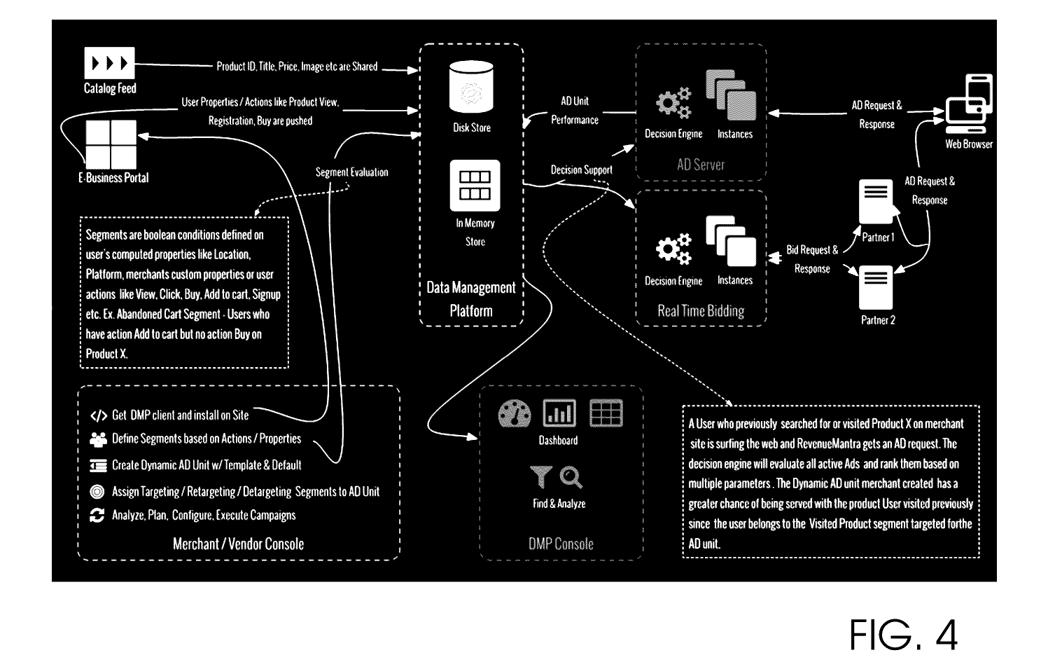

Referring to FIG. 4, a flow chart of an embodiment of the system and method of the present invention is shown. Here, a user's catalog feed is shown transmitting its contents to a data management platform. The data management platform operates the merchant/vendor console, which is what the user uses to create the desire initial parameters of the system. The DMP console is what the user uses to interact with the system. Further, the data management platform regulates the bidding between the ad server and the real-time bidding server. When a potential customer uses their web browser to access a web page with dynamic advertising content on it, a request is sent to the ad server and mediated by the real-time bidding server. The data management platform allows a user to participate in the real-time bidding process.

In another embodiment of the present invention, the system may be adapted and configured to check on the size units and prices of competing products according to location or other criteria. In another embodiment, the system may gather data from a composite of 1st, 2nd and 3rd party sources to make informed recommendations. The system may include a recommendations engine with deep learning algorithms and capabilities in order for intelligent recommendations to be made. In another embodiment of the present invention, analytics and tools for advertisers and publishers would be present to help their audiences.

Systems, Devices and Operating Systems

Typically, a user or users, which may be people or groups of users and/or other systems, may engage information technology systems (e.g., computers) to facilitate operation of the system and information processing. In turn, computers employ processors to process information and such processors may be referred to as central processing units (CPU). One form of processor is referred to as a microprocessor. CPUs use communicative circuits to pass binary encoded signals acting as instructions to enable various operations. These instructions may be operational and/or data instructions containing and/or referencing other instructions and data in various processor accessible and operable areas of memory (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations. One type of program is a computer operating system, which, may be executed by CPU on a computer; the operating system enables and facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the present invention may be connected to and/or communicate with entities such as, but not limited to: one or more users from user input devices; peripheral devices; an optional cryptographic processor device; and/or a communications network. For example, the present invention may be connected to and/or communicate with users, operating client device(s), including, but not limited to, personal computer(s), server(s) and/or various mobile device(s) including, but not limited to, cellular telephone(s), smartphone(s) (e.g., iPhone®, Blackberry®, Android OS-based phones etc.), tablet computer(s) (e.g., Apple iPad™, HP Slate™, Motorola Xoom™, etc.), eBook reader(s) (e.g., Amazon Kindle™, Barnes and Noble's Nook™ eReader, etc.), laptop computer(s), notebook(s), netbook(s), gaming console(s) (e.g., XBOX Live™, Nintendo® DS, Sony PlayStation® Portable, etc.), portable scanner(s) and/or the like.

Networks are commonly thought to comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The present invention may be based on computer systems that may comprise, but are not limited to, components such as: a computer systemization connected to memory.

Computer Systemization

A computer systemization may comprise a clock, central processing unit (“CPU(s)” and/or “processor(s)” (these terms are used interchangeable throughout the disclosure unless noted to the contrary)), a memory (e.g., a read only memory (ROM), a random access memory (RAM), etc.), and/or an interface bus, and most frequently, although not necessarily, are all interconnected and/or communicating through a system bus on one or more (mother)board(s) having conductive and/or otherwise transportive circuit pathways through which instructions (e.g., binary encoded signals) may travel to effect communications, operations, storage, etc. Optionally, the computer systemization may be connected to an internal power source; e.g., optionally the power source may be internal. Optionally, a cryptographic processor and/or transceivers (e.g., ICs) may be connected to the system bus. In another embodiment, the cryptographic processor and/or transceivers may be connected as either internal and/or external peripheral devices via the interface bus I/O. In turn, the transceivers may be connected to antenna(s), thereby effectuating wireless transmission and reception of various communication and/or sensor protocols; for example the antenna(s) may connect to: a Texas Instruments WiLink WL1283 transceiver chip (e.g., providing 802.11n, Bluetooth 3.0, FM, global positioning system (GPS) (thereby allowing the controller of the present invention to determine its location)); Broadcom BCM4329FKUBG transceiver chip (e.g., providing 802.11n, Bluetooth 2.1+EDR, FM, etc.); a Broadcom BCM4750IUB8 receiver chip (e.g., GPS); an Infineon Technologies X-Gold 618-PMB9800 (e.g., providing 2G/3G HSDPA/HSUPA communications); and/or the like. The system clock typically has a crystal oscillator and generates a base signal through the computer systemization's circuit pathways. The clock is typically coupled to the system bus and various clock multipliers that will increase or decrease the base operating frequency for other components interconnected in the computer systemization. The clock and various components in a computer systemization drive signals embodying information throughout the system. Such transmission and reception of instructions embodying information throughout a computer systemization may be commonly referred to as communications. These communicative instructions may further be transmitted, received, and the cause of return and/or reply communications beyond the instant computer systemization to: communications networks, input devices, other computer systemizations, peripheral devices, and/or the like. Of course, any of the above components may be connected directly to one another, connected to the CPU, and/or organized in numerous variations employed as exemplified by various computer systems.

The CPU comprises at least one high-speed data processor adequate to execute program components for executing user and/or system-generated requests. Often, the processors themselves will incorporate various specialized processing units, such as, but not limited to: integrated system (bus) controllers, memory management control units, floating point units, and even specialized processing sub-units like graphics processing units, digital signal processing units, and/or the like. Additionally, processors may include internal fast access addressable memory, and be capable of mapping and addressing memory beyond the processor itself; internal memory may include, but is not limited to: fast registers, various levels of cache memory (e.g., level 1, 2, 3, etc.), RAM, etc. The processor may access this memory through the use of a memory address space that is accessible via instruction address, which the processor can construct and decode allowing it to access a circuit path to a specific memory address space having a memory state. The CPU may be a microprocessor such as: AMD's Athlon, Duron and/or Opteron; ARM's application, embedded and secure processors; IBM and/or Motorola's DragonBall and PowerPC; IBM's and Sony's Cell processor; Intel's Celeron, Core (2) Duo, Itanium, Pentium, Xeon, and/or XScale; and/or the like processor(s). The CPU interacts with memory through instruction passing through conductive and/or transportive conduits (e.g., (printed) electronic and/or optic circuits) to execute stored instructions (i.e., program code) according to conventional data processing techniques. Such instruction passing facilitates communication within the present invention and beyond through various interfaces. Should processing requirements dictate a greater amount speed and/or capacity, distributed processors (e.g., Distributed embodiments of the present invention), mainframe, multi-core, parallel, and/or super-computer architectures may similarly be employed. Alternatively, should deployment requirements dictate greater portability, smaller Personal Digital Assistants (PDAs) may be employed.

Depending on the particular implementation, features of the present invention may be achieved by implementing a microcontroller such as CAST's R8051XC2 microcontroller; Intel's MCS 51 (i.e., 8051 microcontroller); and/or the like. Also, to implement certain features of the various embodiments, some feature implementations may rely on embedded components, such as: Application-Specific Integrated Circuit (“ASIC”), Digital Signal Processing (“DSP”), Field Programmable Gate Array (“FPGA”), and/or the like embedded technology. For example, any of the component collection (distributed or otherwise) and/or features of the present invention may be implemented via the microprocessor and/or via embedded components; e.g., via ASIC, coprocessor, DSP, FPGA, and/or the like. Alternately, some implementations of the present invention may be implemented with embedded components that are configured and used to achieve a variety of features or signal processing.

Depending on the particular implementation, the embedded components may include software solutions, hardware solutions, and/or some combination of both hardware/software solutions. For example, features of the present invention discussed herein may be achieved through implementing FPGAs, which are a semiconductor devices containing programmable logic components called “logic blocks”, and programmable interconnects, such as the high performance FPGA Virtex series and/or the low cost Spartan series manufactured by Xilinx. Logic blocks and interconnects can be programmed by the customer or designer, after the FPGA is manufactured, to implement any of the features of the present invention. A hierarchy of programmable interconnects allow logic blocks to be interconnected as needed by the system designer/administrator of the present invention, somewhat like a one-chip programmable breadboard. An FPGA's logic blocks can be programmed to perform the function of basic logic gates such as AND, and XOR, or more complex combinational functions such as decoders or simple mathematical functions. In most FPGAs, the logic blocks also include memory elements, which may be simple flip-flops or more complete blocks of memory. In some circumstances, the present invention may be developed on regular FPGAs and then migrated into a fixed version that more resembles ASIC implementations. Alternate or coordinating implementations may migrate features of the controller of the present invention to a final ASIC instead of or in addition to FPGAs. Depending on the implementation all of the aforementioned embedded components and microprocessors may be considered the “CPU” and/or “processor” for the present ivention.

Power Source

The power source may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell is connected to at least one of the interconnected subsequent components of the present ivention thereby providing an electric current to all subsequent components. In one example, the power source is connected to the system bus component. In an alternative embodiment, an outside power source is provided through a connection across the I/O interface. For example, a USB and/or IEEE 1394 connection carries both data and power across the connection and is therefore a suitable source of power.

Interface Adapters

Interface bus(ses) may accept, connect, and/or communicate to a number of interface adapters, conventionally although not necessarily in the form of adapter cards, such as but not limited to: input output interfaces (I/O), storage interfaces, network interfaces, and/or the like. Optionally, cryptographic processor interfaces similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces may accept, communicate, and/or connect to a number of storage devices such as, but not limited to: storage devices, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces may accept, communicate, and/or connect to a communications network. Through a communications network, the controller of the present invention is accessible through remote clients (e.g., computers with web browsers) by users. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. Should processing requirements dictate a greater amount speed and/or capacity, distributed network controllers (e.g., Distributed embodiments of the present inveniton), architectures may similarly be employed to pool, load balance, and/or otherwise increase the communicative bandwidth required by the controller of the present invention. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces may be used to engage with various communications network types. For example, multiple network interfaces may be employed to allow for the communication over broadcast, multicast, and/or unicast networks.

Input Output interfaces (I/O) may accept, communicate, and/or connect to user input devices, peripheral devices, cryptographic processor devices, and/or the like. I/O may employ connection protocols such as, but not limited to: audio: analog, digital, monaural, RCA, stereo, and/or the like; data: Apple Desktop Bus (ADB), IEEE 1394a-b, serial, universal serial bus (USB); infrared; joystick; keyboard; midi; optical; PC AT; PS/2; parallel; radio; video interface: Apple Desktop Connector (ADC), BNC, coaxial, component, composite, digital, Digital Visual Interface (DVI), high-definition multimedia interface (HDMI), RCA, RF antennae, S-Video, VGA, and/or the like; wireless transceivers: 802.11a/b/g/n/x; Bluetooth; cellular (e.g., code division multiple access (CDMA), high speed packet access (HSPA(+)), high-speed downlink packet access (HSDPA), global system for mobile communications (GSM), long term evolution (LTE), WiMax, etc.); and/or the like. One typical output device may include a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Another output device is a television set, which accepts signals from a video interface. Typically, the video interface provides the composited video information through a video connection interface that accepts a video display interface (e.g., an RCA composite video connector accepting an RCA composite video cable; a DVI connector accepting a DVI display cable, etc.).

User input devices often are a type of peripheral device (see below) and may include: card readers, dongles, finger print readers, gloves, graphics tablets, joysticks, keyboards, microphones, mouse (mice), remote controls, retina readers, touch screens (e.g., capacitive, resistive, etc.), trackballs, trackpads, sensors (e.g., accelerometers, ambient light, GPS, gyroscopes, proximity, etc.), styluses, and/or the like.

Peripheral devices, such as other components of the cooling chest system, including temperature sensors, ice dispensers (if provided) and the like may be connected and/or communicate to I/O and/or other facilities of the like such as network interfaces, storage interfaces, directly to the interface bus, system bus, the CPU, and/or the like. Peripheral devices may be external, internal and/or part of the controller of the present invention. Peripheral devices may also include, for example, an antenna, audio devices (e.g., line-in, line-out, microphone input, speakers, etc.), cameras (e.g., still, video, webcam, etc.), drive motors, ice maker, lighting, video monitors and/or the like.

Cryptographic units such as, but not limited to, microcontrollers, processors, interfaces, and/or devices may be attached, and/or communicate with the controller of the present invention. A MC68HC16 microcontroller, manufactured by Motorola Inc., may be used for and/or within cryptographic units. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of CPU. Equivalent microcontrollers and/or processors may also be used. Other commercially available specialized cryptographic processors include: the Broadcom's CryptoNetX and other Security Processors; nCipher's nShield, SafeNet's Luna PCI (e.g., 7100) series; Semaphore Communications' 40 MHz Roadrunner 184; Sun's Cryptographic Accelerators (e.g., Accelerator 6000 PCIe Board, Accelerator 500 Daughtercard); Via Nano Processor (e.g., L2100, L2200, U2400) line, which is capable of performing 500+MB/s of cryptographic instructions; VLSI Technology's 33 MHz 6868; and/or the like.

Memory

Generally, any mechanization and/or embodiment allowing a processor to affect the storage and/or retrieval of information is regarded as memory. However, memory is a fungible technology and resource, thus, any number of memory embodiments may be employed in lieu of or in concert with one another. It is to be understood that the controller of the present invention and/or a computer systemization may employ various forms of memory. For example, a computer systemization may be configured wherein the functionality of on-chip CPU memory (e.g., registers), RAM, ROM, and any other storage devices are provided by a paper punch tape or paper punch card mechanism; of course such an embodiment would result in an extremely slow rate of operation. In a typical configuration, memory will include ROM, RAM, and a storage device. A storage device may be any conventional computer system storage. Storage devices may include a drum; a (fixed and/or removable) magnetic disk drive; a magneto-optical drive; an optical drive (i.e., Blueray, CD ROM/RAM/Recordable (R)/ReWritable (RW), DVD R/RW, HD DVD R/RW etc.); an array of devices (e.g., Redundant Array of Independent Disks (RAID)); solid state memory devices (USB memory, solid state drives (SSD), etc.); other processor-readable storage mediums; and/or other devices of the like. Thus, a computer systemization generally requires and makes use of memory.

Component Collection

The memory may contain a collection of program and/or database components and/or data such as, but not limited to: operating system component(s) (operating system); information server component(s) (information server); user interface component(s) (user interface); Web browser component(s) (Web browser); database(s); mail server component(s); mail client component(s); cryptographic server component(s) (cryptographic server) and/or the like (i.e., collectively a component collection). These components may be stored and accessed from the storage devices and/or from storage devices accessible through an interface bus. Although non-conventional program components such as those in the component collection, typically, are stored in a local storage device, they may also be loaded and/or stored in memory such as: peripheral devices, RAM, remote storage facilities through a communications network, ROM, various forms of memory, and/or the like.

Operating System

The operating system component is an executable program component facilitating the operation of the controller of the present invention. Typically, the operating system facilitates access of I/O, network interfaces, peripheral devices, storage devices, and/or the like. The operating system may be a highly fault tolerant, scalable, and secure system such as: Apple Macintosh OS X (Server); AT&T Plan 9; Be OS; Unix and Unix-like system distributions (such as AT&T's UNIX; Berkley Software Distribution (BSD) variations such as FreeBSD, NetBSD, OpenBSD, and/or the like; Linux distributions such as Red Hat, Ubuntu, and/or the like); and/or the like operating systems. However, more limited and/or less secure operating systems also may be employed such as Apple Macintosh OS, IBM OS/2, Microsoft DOS, Microsoft Windows 2000/2003/3.1/95/98/CE/Millennium/NT/Vista/XP (Server), Palm OS, and/or the like. The operating system may be one specifically optimized to be run on a mobile computing device, such as iOS, Android, Windows Phone, Tizen, Symbian, and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the controller of the present invention to communicate with other entities through a communications network. Various communication protocols may be used by the controller of the present invention as a subcarrier transport mechanism for interaction, such as, but not limited to: multicast, TCP/IP, UDP, unicast, and/or the like.

Information Server

An information server component is a stored program component that is executed by a CPU. The information server may be a conventional Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective-) C (++), C# and/or .NET, Common Gateway Interface (CGI) scripts, dynamic (D) hypertext markup language (HTML), FLASH, Java, JavaScript, Practical Extraction Report Language (PERL), Hypertext Pre-Processor (PHP), pipes, Python, wireless application protocol (WAP), WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM), Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Yahoo! Instant Messenger Service, and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the controller of the present invention based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/mylnformation.html” portion of the request and resolve it to a location in memory containing the information “mylnformation.html.” Additionally, other information serving protocols may be employed across various ports, e.g., FTP communications across port, and/or the like. An information server may communicate to and/or with other components in a component collection, including itself, and/or facilities of the like. Most frequently, the information server communicates with the database of the present invention, operating systems, other program components, user interfaces, Web browsers, and/or the like.

Access to the database of the present invention may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the present invention. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the present invention as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

User Interface

Computer interfaces in some respects are similar to automobile operation interfaces. Automobile operation interface elements such as steering wheels, gearshifts, and speedometers facilitate the access, operation, and display of automobile resources, and status. Computer interaction interface elements such as check boxes, cursors, menus, scrollers, and windows (collectively and commonly referred to as widgets) similarly facilitate the access, capabilities, operation, and display of data and computer hardware and operating system resources, and status. Operation interfaces are commonly called user interfaces. Graphical user interfaces (GUIs) such as the Apple Macintosh Operating System's Aqua, IBM's OS/2, Microsoft's Windows 2000/2003/3.1/95/98/CE/Millennium/NT/XP/Vista/7 (i.e., Aero), Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D)HTML, FLASH, Java, JavaScript, etc. interface libraries such as, but not limited to, Dojo, jQuery(UI), MooTools, Prototype, script.aculo.us, SWFObject, Yahoo! User Interface, any of which may be used and) provide a baseline and means of accessing and displaying information graphically to users.

A user interface component is a stored program component that is executed by a CPU. The user interface may be a conventional graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

Web Browser

A Web browser component is a stored program component that is executed by a CPU. The Web browser may be a conventional hypertext viewing application such as Microsoft Internet Explorer or Netscape Navigator. Secure Web browsing may be supplied with 128 bit (or greater) encryption by way of HTTPS, SSL, and/or the like. Web browsers allowing for the execution of program components through facilities such as ActiveX, AJAX, (D)HTML, FLASH, Java, JavaScript, web browser plug-in APIs (e.g., FireFox, Safari Plug-in, and/or the like APIs), and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Of course, in place of a Web browser and information server, a combined application may be developed to perform similar functions of both. The combined application would similarly affect the obtaining and the provision of information to users, user agents, and/or the like from the enabled nodes of the present invention. The combined application may be nugatory on systems employing standard Web browsers.

Mail Server

A mail server component is a stored program component that is executed by a CPU. The mail server may be a conventional Internet mail server such as, but not limited to sendmail, Microsoft Exchange, and/or the like. The mail server may allow for the execution of program components through facilities such as ASP, ActiveX, (ANSI) (Objective-) C (++), C# and/or .NET, CGI scripts, Java, JavaScript, PERL, PHP, pipes, Python, WebObjects, and/or the like. The mail server may support communications protocols such as, but not limited to: Internet message access protocol (IMAP), Messaging Application Programming Interface (MAPI)/Microsoft Exchange, post office protocol (POP3), simple mail transfer protocol (SMTP), and/or the like. The mail server can route, forward, and process incoming and outgoing mail messages that have been sent, relayed and/or otherwise traversing through and/or to the present invnetion.

Access to the mail of the present invention may be achieved through a number of APIs offered by the individual Web server components and/or the operating system.

Also, a mail server may contain, communicate, generate, obtain, and/or provide program component, system, user, and/or data communications, requests, information, and/or responses.

Mail Client

A mail client component is a stored program component that is executed by a CPU. The mail client may be a conventional mail viewing application such as Apple Mail, Microsoft Entourage, Microsoft Outlook, Microsoft Outlook Express, Mozilla, Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

Cryptographic Server

A cryptographic server component is a stored program component that is executed by a CPU, cryptographic processor, cryptographic processor interface, cryptographic processor device, and/or the like. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash function), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the present invention may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for an digital audio file. A cryptographic component may communicate to and/or with other components in a component collection, including itself, and/or facilities of the like. The cryptographic component supports encryption schemes allowing for the secure transmission of information across a communications network to enable the component of the present invention to engage in secure transactions if so desired. The cryptographic component facilitates the secure accessing of resources on the present invention and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

The Database of the Present Invention

The database component of the present invention may be embodied in a database and its stored data. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the database of the present invention may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of functionality encapsulated within a given object. If the database of the present invention is implemented as a data-structure, the use of the database of the present invention may be integrated into another component such as the component of the present invention. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database component includes several tables. A Users (e.g., operators and physicians) table may include fields such as, but not limited to: user_id, ssn, dob, first_name, last_name, age, state, address_firstline, address_secondline, zipcode, devices_list, contact_info, contact_type, alt_contact_info, alt_contact_type, and/or the like to refer to any type of enterable data or selections discussed herein. The Users table may support and/or track multiple entity accounts. A Clients table may include fields such as, but not limited to: user_id, client_id, client_ip, client_type, client_model, operating_system, os_version, app_installed_flag, and/or the like. An Apps table may include fields such as, but not limited to: app_ID, app_name, app_type, OS_compatibilities_list, version, timestamp, developer_ID, and/or the like. A beverages table including, for example, heat capacities and other useful parameters of different beverages, such as depending on size beverage_name, beverage_size, desired_coolingtemp, cooling_time, favorite_drinker, number_of beverages, current_beverage_temperature, current_ambient_temperature, and/or the like. An Parameter table may include fields including the foregoing fields, or additional ones such as cool_start_time, cool_preset, cooling_rate, and/or the like. A Cool Routines table may include a plurality of cooling sequences may include fields such as, but not limited to: sequence_type, sequence_id, flow_rate, avg_water_temp, cooling_time, pump_setting, pump_speed, pump_pressure, power_level, temperature_sensor_id_number, temperature_sensor_location, and/or the like.

In one embodiment, user programs may contain various user interface primitives, which may serve to update the platform of the present invention. Also, various accounts may require custom database tables depending upon the environments and the types of clients the system of the present invention may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components. The system of the present invention may be configured to keep track of various settings, inputs, and parameters via database controllers.

Various other components may be included and called upon for providing for aspects of the teachings herein. For example, additional materials, combinations of materials and/or omission of materials may be used to provide for added embodiments that are within the scope of the teachings herein. In the present application a variety of variables are described, including but not limited to components and conditions. It is to be understood that any combination of any of these variables can define an embodiment of the disclosure. Other combinations of articles, components, conditions, and/or methods can also be specifically selected from among variables listed herein to define other embodiments, as would be apparent to those of ordinary skill in the art.

When introducing elements of the present disclosure or the embodiment(s) thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements.

While the disclosure refers to exemplary embodiments, it will be understood by those skilled in the art that various changes may be made and equivalents may be substituted for elements thereof without departing from the scope of the disclosure. In addition, many modifications will be appreciated by those skilled in the art to adapt a particular instrument, situation or material to the teachings of the disclosure without departing from the spirit thereof. Therefore, it is intended that the disclosure not be limited to the particular embodiments disclosed.

What is claimed is:

1. A method of advertising, comprising the steps of:
obtaining, at least one item of information from at least one data source;
transforming, said at least one item of information into a product catalog, said product catalog comprising at least one product;
creating, via a data management platform having a user-interface console, at least one audience segment from at least one criterion;
creating, via said data management platform at least one promotion, wherein said promotion is designed to advertise said at least one product to said at least one segment.

2. The method of claim 1, further comprising the steps of:
publishing, said at least one promotion, on a given website,
fetching an advertisement comprising at least one item of data.

3. The method of claim 2, further comprising the step of:
logging, an amount of advertisements fetched by said at least one promotion.

4. The method of claim 3, further comprising the step of:
visualizing, said at least one item of data.

5. The method of claim 1, wherein said at least one criterion is selected from the group consisting of: operating system used, region, country, browser, name, device, city, region, sate, product ID, age, income band, gender, profession, and country.

6. The method of claim 1, wherein said at least one promotion is selected from the group consisting of: banner advertisements, dynamic banner advertisements, mobile advertisements, and video advertisements.

7. The method of claim 6, wherein said dynamic banner advertisements incorporate said product catalog.

8. The method of claim 1, wherein said product catalog is developed from remnant inventory.

9. The method of claim 1, wherein said promotion has a layout that is customized for a given user.

10. The method of claim 1, wherein said at least one information source is a product feed URL.

11. The method of claim 1, wherein the step of obtaining, at least one item of information from at least one data source is performed by automatically crawling said at least one data source for said at least one item of information.

12. The method of claim 1, wherein said at least one data source is a catalog feed.

13. The method of claim 2, wherein said advertisement is a digital advertisement.

14. A system comprising:
a memory that stores computer-executable instructions; and
a processor, communicatively coupled to said memory that facilitates execution of the computer-executable instructions which comprises:
a data management platform having a user-interface console and at least one store,
wherein said user-interface console is comprised of a dashboard displayed on a viewing screen;
at least one instance of a real-time bidding server having a decision engine;
wherein said real-time bidding server interfaces with at least one instance of an advertising exchange server,
wherein said data management platform receives at least one item of information from a catalog feed and is capable of generating a promotion.

15. The system of claim 13, wherein said console enables a user to:
define at least one audience segment;
create at least one dynamic advertising unit;
assign said at least one audience segment to said at least one dynamic advertising unit;
analyze a digital advertising campaign;
prepare a digital advertising campaign;
configure a digital advertising campaign; and
execute a digital advertising campaign.

16. The system of claim 14, wherein the at least one dynamic advertising unit is constructed from a predetermined template.

17. The system of claim 14, wherein the segment is defined by at least one parameter selected from the group consisting of: operating system used, region, country, browser, name, device, city, region, sate, product ID, age, income band, gender, profession, and country.
